(19) United States
(12) Patent Application Publication
(10) Pub. No.: US 2011/0235828 A1
(43) Pub. Date: Sep. 29, 2011

(54) MICROPHONE AND A SWITCH LOCKING DEVICE THEREOF

(76) Inventor: Kang-Chao Chang, Chiayi City (TW)

(21) Appl. No.: 12/732,790

(22) Filed: Mar. 26, 2010

(51) Int. Cl. H04R 1/04

(52) U.S. Cl. 381/123

(57) ABSTRACT

A microphone includes a grip and an audio pick-up unit mounted to one end of the grip. The microphone further includes a switch disposed in the grip and having an operable part that is movable relative to the grip between on and off positions. The microphone also includes a switch actuator movably disposed on the grip, coupled to the operable part of the switch, and manually operable to drive the operable part to move between the on and off positions. The microphone further includes a locking member movably disposed on the grip and manually operable for movement between a locking position and an unlocking position.

### BACKGROUND OF THE INVENTION

1. Field of the Invention

The invention relates to a microphone, and more particularly to a switch locking device of a microphone.

2. Description of the Related Art

A microphone may have a power switch provided on a grip of the microphone that can be accidentally moved. For example, while a user is holding a microphone during a speech or a singing performance, the power switch may be accidentally moved and the microphone may be turned off. Turning off the microphone during use may have an adverse effect on a user's performance or speech.

### SUMMARY OF THE INVENTION

The main object of the present invention is to provide a microphone having a switch locking function for preventing undesired operation of a switch of the microphone.

Accordingly, a microphone of the present invention comprises a grip and an audio pick-up unit mounted to one end of the grip. The microphone further comprises a switch disposed in the grip and having an operable part that is movable relative to the grip between on and off positions. The microphone also comprises a switch actuator movably disposed on the grip, coupled to the operable part of the switch, and manually operable to drive the operable part to move between the on and off positions.

The microphone further comprises a locking member movably disposed on the grip and manually operable for movement between a locking position, where the locking member blocks movement of the switch actuator such that movement of the operable part from the on position to the off position is prevented, and an unlocking position, where the locking member permits movement of the switch actuator such that movement of the operable part between the on and off positions is permitted.

An advantage of the present invention is: when the switch actuator is disposed at the on position, the locking member may be moved to the locking position to block movement of the switch actuator, thus preventing the operable part of the switch from moving from the on position to the off position. Interruption of the microphone's operation due to accidental movement of the switch actuator is thus prevented.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a microphone having a switch locking device, according to a preferred embodiment of the present invention;

FIG. 2 is an enlarged fragmentary partly exploded perspective view of the preferred embodiment;

FIG. 3 is an enlarged fragmentary view illustrating a switch actuator at an off position and a locking member at an unlocking position, according to the preferred embodiment;

FIG. 4 is an enlarged fragmentary view illustrating the switch actuator at an on position and the locking member at the unlocking position, according to the preferred embodiment; and

FIG. 5 is an enlarged fragmentary view illustrating the switch actuator at the on position and the locking member at a locking position, according to the preferred embodiment.

### DETAILED DESCRIPTION OF THE PREFERRED EMBODIMENT

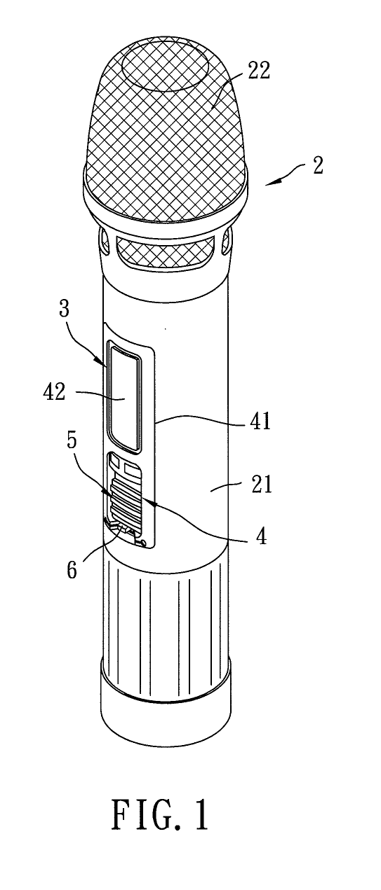

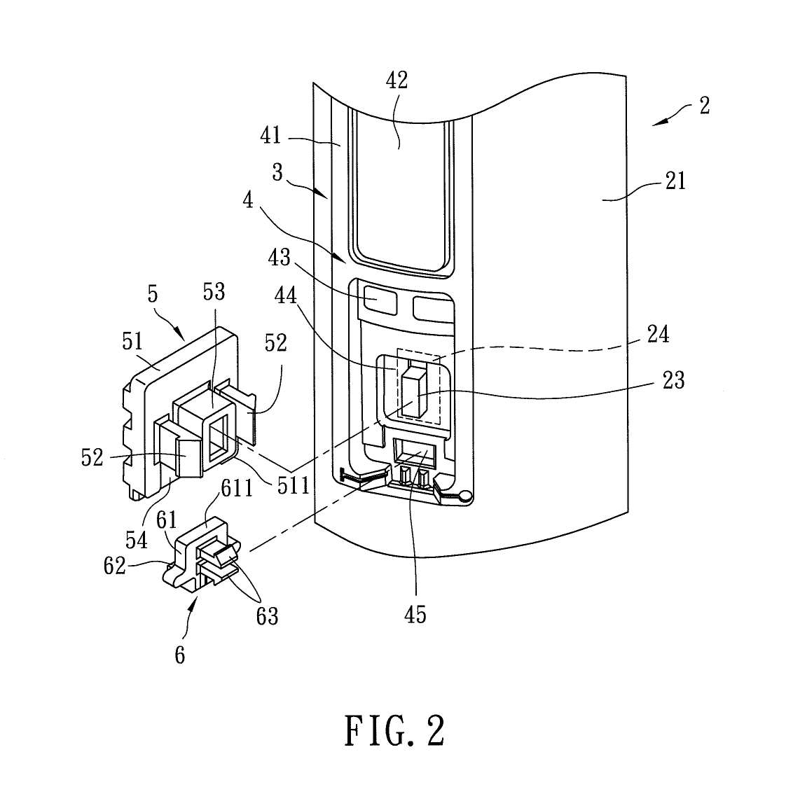

Referring to FIGS. 1 and 2, the preferred embodiment of a microphone 2 having a switch locking device 3 according to the present invention is shown to include a grip 21 and an audio pick-up unit 22 mounted to one end of the grip 21. In variations of the preferred embodiment, the audio pick-up unit 22 may be located on or within any part of the microphone 2, such as an end, a midsection, or a side of the microphone 2.

The microphone 2 further includes a switch 24 disposed in the grip 21 and that has an operable part 23 movable relative to the grip 21 between on and off positions. The operable part 23 of the switch 24 may be mounted in the grip 21 and have a button that protrudes outwardly from the grip 21. The operable part 23 may be vertically movable.

The switch locking device 3 includes a mounting panel 4 mounted on the grip 21. The switch locking device 3 further includes a switch actuator 5 and a locking member 6, each mounted slidably on the mounting panel 4. The switch actuator 5 is manually operable to drive the operable part 23 between the on and off positions, and the locking member 6 is manually operable between a locking position and an unlocking position. The operations of the switch actuator 5 and the locking member 6 are described in greater detail below.

In the embodiment, the grip 21 has a cylindrical shape, and the mounting panel 4 is embedded in a side of the grip 21. In variations of the preferred embodiment, the grip 21 and the mounting panel 4 may be formed using a combination of flat or rounded surfaces. Accordingly, the shapes of the mounting panel 4 and the grip 21 are not limited to the illustration of the preferred embodiment.

The mounting panel 4 includes a panel body 41 mounted on the grip 21 over the operable part 23, a display 42 mounted on the panel body 41 to display an operating status of the microphone 2, and a pair of adjustment buttons 43 mounted on the panel body 41 for controlling the operating status of the microphone 2. The mounting panel 4 is formed with a first opening 44 over the panel body 41, and formed with a second opening 45 disposed below the first opening 44. The first opening 44 extends vertically, and the second opening 45 extends horizontally. In variations of the preferred embodiment, the first opening 44 or the second opening 45 may each be formed with any shape. In this embodiment, the display 42 is disposed at an upper portion of the panel body 41, and the adjustment buttons 43 are disposed below the display 42.

The switch actuator 5 includes an actuator plate 51 mounted on the surface of the panel body 41. The actuator plate 51 of the switch actuator 5 has a bottom portion 511 formed with a receiving space 54. The switch actuator 5 further includes a first hook part 52 with a pair of hooks that each extend from an inner side of the actuator plate 51 into the first opening 44. The hooks of the first hook part 52 are slidably hooked to the panel body 41 of the mounting panel 4. Engagement between the first hook part 52 and the panel body 41 permits the actuator plate 51 of the switch actuator 5 to move vertically along the first opening 44 between on and off positions.

The switch actuator 5 also includes a sleeve part 53 for sleeving engagement with the operable part 23. The sleeve part 53 is disposed between the hooks of the first hook part 52. The sleeve part 53 couples the switch actuator 5 to the operable part 23 of the switch 24, allowing manual operation of the switch actuator 5 to drive the operable part 23 between on and off positions. In other words, the switch actuator 5 is movably disposed on the grip 21, and is coupled to the operable part 23 of the switch 24. Movement of the switch actuator 5 may thus be used to operate the audio pick-up unit 22. In variations of the preferred embodiment, the switch actuator 5 or the operable part 23 of the switch 24 may be moved in any other direction relative to the grip 21, such as vertically, horizontally, or along a curved path.

The locking member 6 is mounted on the panel body 41 of the mounting panel 4 and below the switch actuator 5. The locking member 6 includes a locking plate 61 mounted on an outer side of the panel body 41, and a tab 62 that protrudes from the locking plate 61 away from the grip 21 for user manipulation. The locking plate 61 is formed with a blocking part 611.

The locking plate 61 further includes a second hook part 63 with a pair of hooks that are vertically spaced apart. Each hook of the second hook part 63 extends from an inner side of the locking plate 61 into the second opening 45 and abuts against an inner side of the panel body 41. The hooks of the second hook part 63 are slidably hooked to the panel body 41 of the mounting panel 4.

Engagement between the second hook part 63 and the panel body 41 permits the locking plate 61 to move horizontally along the second opening 45 and along a bottom edge of the switch actuator 5 between a locking position and an unlocking position. The locking member 6 is thus movably disposed on the grip 21 and manually operable for movement between a locking position and an unlocking position.

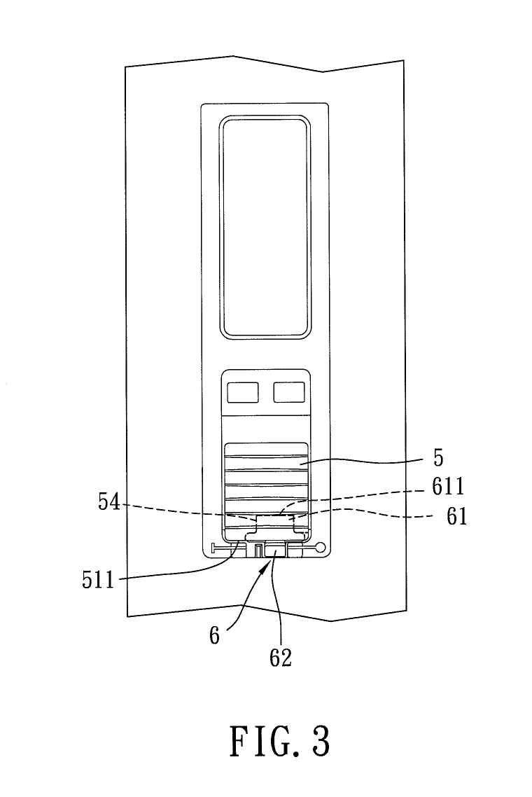

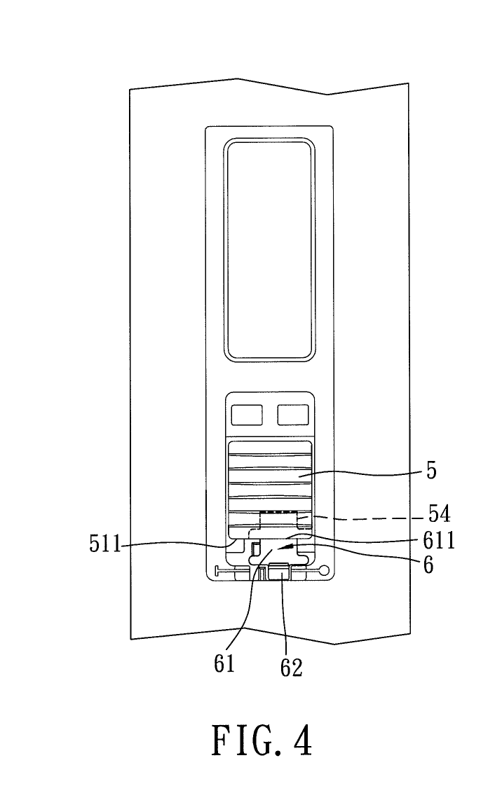

When the locking member 6 is disposed at the unlocking position as shown in FIGS. 3 and 4, the locking member 6 permits movement of the switch actuator 5 such that movement of the operable part 23 between the on and off positions is permitted. The switch actuator 5 is movable between the on position as shown in FIG. 4 and the off position as shown in FIG. 3 to operate the audio pick-up unit 22. When the locking member 6 is disposed at the unlocking position and the switch actuator 5 is disposed at the off position, the locking plate 61 extends into the receiving space 54, as shown in FIG. 3.

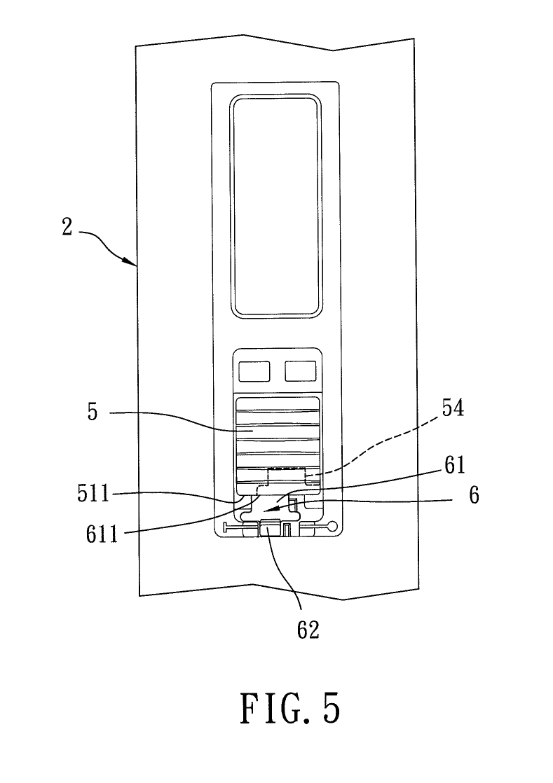

When the switch actuator 5 is moved to the on position as shown in FIG. 4, the tab 62 can be manually operated to slide the locking member 6 to the locking position as shown in FIG. 5. At the locking position, the blocking part 611 of the locking plate 61 abuts against the bottom portion 511 of the switch actuator 5, which blocks movement of the switch actuator 5 from the on position to the off position. This prevents the operable part 23 of the switch 24 from moving from the on position to the off position. In variations of the preferred embodiment, the locking member 6 may be moved in any direction relative to the grip 21, such as vertically, horizontally, or along a curved path.

When the microphone 2 is used, such as for a speech or for singing, the switch actuator 5 is first moved from the off position to the on position, which drives the operable part 23 of the switch 24 from the off position to the on position. The locking member 6 is then moved to the locking position to abut against and to block movement of the switch actuator 5. This prevents the operable part 23 of the switch 24 from moving from the on position to the off position. Accordingly, interruption of the microphone's 2 operation from accidental movement of the switch actuator 5 is prevented.

When the microphone 2 is to be deactivated, the locking member 6 is moved from the locking position to the unlocking position. The switch actuator 5 may then be moved from the on position to the off position, which drives the operable part 23 of the switch 24 from the on position to the off position. When the switch actuator 5 is at the off position, the locking plate 61 of the locking member 6 extends into the receiving space 54.

In summary, when the switch actuator 5 is disposed at the on position, the locking member 6 may be moved to a locking position to block movement of the switch actuator 5, thus preventing the operable part 23 of the switch 24 from moving from an on position to an off position. Interruption of the microphone's 2 operation due to accidental movement of the switch actuator 5 is thus prevented.

While the present invention has been described in connection with what is considered the most practical and preferred embodiment, it is understood that this invention is not limited to the disclosed embodiment but is intended to cover various arrangements included within the spirit and scope of the broadest interpretation to encompass all such modifications and equivalent arrangements.

What is claimed is:

1. A microphone comprising:
a grip;
an audio pick-up unit mounted to one end of said grip;
a switch disposed in said grip and having an operable part that is movable relative to said grip between on and off positions;
a switch actuator movably disposed on said grip, coupled to said operable part of said switch, and manually operable to drive said operable part to move between the on and off positions; and
a locking member movably disposed on said grip and manually operable for movement between a locking position, where said locking member blocks movement of said switch actuator such that movement of said operable part from the on position to the off position is prevented, and an unlocking position, where said locking member permits movement of said switch actuator such that movement of said operable part between the on and off positions is permitted.

2. The microphone as claimed in claim 1, further comprising amounting panel mounted on said grip, each of said switch actuator and said locking member being mounted slidably on said mounting panel.

3. The microphone as claimed in claim 2, wherein said mounting panel body is formed with first and second openings,
said switch actuator includes an actuator plate and a first hook part that extends from said actuator plate through said first opening and that is slidably hooked onto said mounting panel, and
said locking member includes a locking plate and a second hook part that extends from said locking plate through said second opening and that is slidably hooked onto said mounting panel.

4. The microphone as claimed in claim 3, wherein said first opening extends vertically, said second opening extends horizontally and is disposed below said first opening, said switch actuator is movable vertically along said first opening for driving movement of said operable part between the on and off positions when said locking member is at the unlocking position, and said locking member is movable horizontally along said second opening between the locking and unlocking positions.

5. The microphone as claimed in claim 4, wherein said locking plate is formed with a blocking part that abuts against a bottom portion of said actuator plate to block movement of said switch actuator when said locking member is at the locking position, and said actuator plate is formed with a receiving space that permits said blocking part to extend therein when said locking member is at the unlocking position such that movement of said switch actuator for driving movement of said operable part between the on and off positions is permitted.

6. The microphone as claimed in claim 3, wherein said locking member further includes a tab that protrudes from said locking plate away from said grip for user manipulation.

7. The microphone as claimed in claim 3, wherein said switch actuator further includes a sleeve part projecting from said actuator plate for sleeving engagement with said operable part of said switch.

8. The microphone as claimed in claim 2, further comprising a display mounted on said mounting panel for displaying operating status of said microphone.

9. The microphone as claimed in claim 2, further comprising an adjustment button disposed on said mounting panel and operable for controlling operating status of said microphone.

10. A switch locking device for a microphone, the microphone including a grip, an audio pick-up unit mounted to one end of the grip, and a switch disposed in the grip and having an operable part that is movable relative to the grip between on and off positions, said switch locking device comprising:
a switch actuator adapted to be movably disposed on the grip, adapted to be coupled to the operable part of the switch, and manually operable to drive the operable part to move between the on and off positions; and
a locking member adapted to be movably disposed on the grip and manually operable for movement between a locking position, where said locking member blocks movement of said switch actuator such that movement of the operable part from the on position to the off position is prevented, and an unlocking position, where said locking member permits movement of said switch actuator such that movement of the operable part between the on and off positions is permitted.

11. The switch locking device for a microphone as claimed in claim 10, further comprising a mounting panel adapted to be mounted on the grip, each of said switch actuator and said locking member being mounted slidably on said mounting panel.

12. The switch locking device for a microphone as claimed in claim 11, wherein said mounting panel is formed with first and second openings,
said switch actuator includes an actuator plate and a first hook part that extends from said actuator plate through said first opening and that is slidably hooked onto said mounting panel, and
said locking member includes a locking plate and a second hook part that extends from said locking plate through said second opening and that is slidably hooked onto said mounting panel.

13. The switch locking device for a microphone as claimed in claim 12, wherein said first opening extends vertically, said second opening extends horizontally and is disposed below said first opening, said switch actuator is movable vertically along said first opening for driving movement of the operable part between the on and off positions when said locking member is at the unlocking position, and said locking member is movable horizontally along said second opening between the locking and unlocking positions.

14. The switch locking device for a microphone as claimed in claim 13, wherein said locking plate is formed with a blocking part that abuts against a bottom portion of said actuator plate to block movement of said switch actuator when said locking member is at the locking position, and said actuator plate is formed with a receiving space that permits said blocking part to extend therein when said locking member is at the unlocking position such that movement of said switch actuator for driving movement of said operable part between the on and off positions is permitted.

15. The switch locking device for a microphone as claimed in claim 12, wherein said locking member further includes a tab that protrudes from said locking plate away from the grip for user manipulation.

16. The switch locking device for a microphone as claimed in claim 12, wherein said switch actuator further includes a sleeve part projecting from said actuator plate and configured for sleeving engagement with the operable part of the switch.
